(19) United States
(12) Patent Application Publication
(10) Pub. No.: US 2013/0224619 A1
(43) Pub. Date: Aug. 29, 2013

(54) Coolant Circuit for a Fuel Cell System, and Method for Fluidically Coupling an Ion Exchange Module to a Component of a Coolant Circuit

(71) Applicants: Wolfgang Schwienbacher, Dettingen (DE); Mario Mittmann, Owen (DE)

(72) Inventors: Wolfgang Schwienbacher, Dettingen (DE); Mario Mittmann, Owen (DE)

(73) Assignee: Daimler AG, Stuttgart (DE)

(21) Appl. No.: 13/823,796

(22) PCT Filed: Nov. 4, 2011
(86) PCT No.: PCT/EP2011/005559

§ 371 Date: Apr. 9, 2013

(30) Foreign Application Priority Data
Nov. 13, 2010 (DE) 102010051343.1

(51) Int. Cl. H01M 8/04

(52) U.S. Cl. CPC H01M 8/04044
USPC 429/437

(57) ABSTRACT

A coolant circuit for a fuel cell system of a motor vehicle includes an ion exchange module fluidically coupled to a component of the coolant circuit, which is flowed through by coolant during a cooling operation. The ion exchange module is fixed to an external wall of the component. A fastening element couples the ion exchange module fluidically to the component.

### BACKGROUND AND SUMMARY OF THE INVENTION

Exemplary embodiments of the present invention relate to a coolant circuit for a fuel cell system, in particular of a motor vehicle, having an ion exchange module, which is fluidically coupled with a component of the coolant circuit that is flowed through by the coolant during the cooling operation. Exemplary embodiments of the present invention also relate to a method for the fluidic coupling of an ion exchange module with a component of a coolant circuit.

German Patent Document DE 10 2009 012 379 A1 describes a coolant-equalizing reservoir arranged in a coolant circuit for a fuel cell system. The coolant circuit cools a fuel cell sequence of the fuel cell system. The coolant-equalizing reservoir has an inlet and an outlet for the coolant. An ion exchange cartridge is inserted into the coolant reservoir and is in fluidic communication with the inlet. Coolant entering the coolant reservoir thus flows through the ion exchange cartridge and leaves it through the outlet window that is permeable for the coolant. The coolant, which is de-ionised by an ion exchange resin, then flows to the fuel cell sequence via the outlet of the coolant-equalizing reservoir.

In such a coolant circuit the ion exchange cartridge must be renewed comparably often.

Exemplary embodiments of the present invention provide a coolant circuit and a method that enables particularly long durability of the ion exchange module.

The coolant circuit for a fuel cell system according to the invention comprises an ion exchange module, which is fluidically coupled to a component of the coolant circuit that is flowed through by the coolant during the cooling operation. The ion exchange module is hereby fixed to an external wall of the component. Due to the fact that the ion exchange module is not stored in the interior of the component, the coolant does not come into contact with the external wall of the ion exchange module during the cooling operation. Potential sullying of the external wall of the ion exchange module therefore does not lead to sullying of the coolant. The insertion of impurities into the coolant during the handling of the ion exchange module, for example during mounting, demounting or maintenance of the ion exchange module, can thus be avoided. This allows the ion exchange module to be used over a particularly long time-frame. The long maintenance intervals that accompany the long time-frame are also advantageous with respect to the costs and effort for a user of the fuel cell system, in particular if this is to be used in a vehicle.

Furthermore, particularly good accessibility to the ion exchange module is provided, such that service and maintenance operations can be carried out with particular ease. Avoiding insertion of impurities into the coolant of the coolant circuit also leads to the conductivity of the coolant being maintained at a particularly low level. Since the coolant in the fuel cell system flows approximately through the fuel cell sequence and thus through electrically conductive components, avoiding ion insertion into the coolant also provides increased security during the operation of the coolant circuit and the fuel cell system.

By attaching the ion exchange module to the external wall of the component, it can furthermore be ensured that a very small contact region of the ion exchange module exists at the component of the coolant circuit, which is also advantageous with respect to avoiding insertion of impurities into the coolant.

In an advantageous embodiment of the invention, the ion exchange module is fixed to the external wall of the component by means of at least one of the fastening elements through which the coolant can flow. The fluidic coupling of the ion exchange module with the component of the coolant circuit thus takes place in a particularly simple and functionally secure manner, just by attaching the ion exchange module to the external wall of the component. Thus, a particularly clean and quick mounting and demounting of the ion exchange module is achieved. The potentially quick demounting of an ion exchange module, the ion exchange material of which is charged, and the quick mounting of a still-uncharged ion exchange module leads to the coolant circuit only needing to be opened for a very short period of time, such that the insertion of impurities into the coolant can also be considerably prevented in this way.

Even if the component of the coolant circuit is to be exchanged or maintained, this can be uncoupled from the ion exchange module in a particularly simple manner, such that all mounting, service and maintenance operations can be carried out particularly simply and error-free. The prevention of an insertion of impurities into the coolant during the aforementioned operations ensures that limitations during the operation of the fuel cell system, in particular while driving, can largely be avoided.

It has hereby been shown to be advantageous if, due to the arrangement of the at least one fastening element, a mounting device is provided during the coupling of the ion exchange module with the component. Defective mounting is thus prevented in a particularly extensive manner, and the full functionality of the ion exchange module can be securely achieved when it is coupled with the component.

It is furthermore advantageous if a receiving region for the ion exchange module is provided by the external wall of the component. This enables a particularly compact, space-efficient design of an assembly of the coolant circuit that comprises the component and the ion exchange module. This particularly applies if the receiving region of the ion exchange module can be filled in such a way that the ion exchange module closes flush with the external wall of the component.

In order to ensure a controlled connection of the ion exchange module to the component of the coolant circuit, various arrangements of the at least one fastening element are possible.

Thus, the ion exchange module can have a floor with a step, wherein, respectively, at least one fastening element can be arranged at a region of the floor that is arranged to be displaced around the height of the step. Such an arrangement of the fastening elements enables mounting of the ion exchange module in a direction that is perpendicular to the regions of the floor that possess the fastening elements.

Additionally or alternatively, at least two fastening elements can be arranged on a side wall of the ion exchange module. Then a side mounting of the ion exchange module onto the component can take place accordingly.

Additionally or alternatively, a first fastening element can be arranged on a side wall and a second fastening element can be arranged on a floor of the ion exchange module. A mounting or demounting of the ion exchange module can be provided in a direction that is both flush to the side wall and flush to the floor. A coupling via one of the two fastening elements can also first occur, wherein this then takes place fundamentally perpendicular to the floor or to the side wall. Then, due to a rotational movement, the complete coupling of the ion exchange module with the component is achieved via the second fastening element.

The possibilities cited for the controlled connection of the ion exchange module with the component of the coolant circuit ensures a mounting and demounting of the ion exchange module that is particularly procedurally secure.

The at least one fastening element can comprise a socket arranged on the ion exchange module and/or on the component of the coolant circuit. This enables a secure, fluidic coupling of the ion exchange module with the component.

If the at least one fastening element comprises a bayonet lock and/or a latching element and/or a screw thread, a form fit connection of the ion exchange module and the component can be achieved in a particularly simple manner. With such a fastening of the ion exchange module to the component, the ion exchange module is held securely to the component of the coolant circuit, even when there are typical vibrations (jarring) occurring during the drive operation, without it slackening or being released.

Furthermore, in the region of the fastening element, a sealing element and/or a filter is preferably provided. Such a filter, for example in the form of a mat, in particular formed from fiber glass, a membrane or a netting (formed, for example, from synthetic material), leads to the ion exchange material being retained in the ion exchange module, even during the cooling operation, if the ion exchange module is flowed through by coolant, and it can achieve its function there, namely ion exchange. Furthermore, such a contamination of the coolant with particles that are discharged from the ion exchange module is thus avoided. The sealing element enables the ion exchange module to be fit tightly to the component of the coolant circuit when it is being mounted.

In a further advantageous embodiment of the invention, a locking element is provided in the region of the at least one fastening element to prevent coolant escaping from the component when the ion exchange module is uncoupled from the component. Such a locking element thus prevents insertion of impurities into the component via the fastening element, if the ion exchange module is demounted from the component. It is preferable for the locking element to be designed for automatic prevention of coolant escape.

In a further advantageous embodiment of the invention, a first fastening element is surrounded by a second fastening element at its peripheral surface. The coolant can thus enter the ion exchange module and an exit that is coaxial to the entry can be achieved from this. Additionally, the fastening of the ion exchange module to the component of the coolant circuit can thus be implemented in a particularly simple manner.

At least one flow guiding element can be arranged in the ion exchange module, which provides a flow path for the coolant through the ion exchange module. Such a short-circuit flow through the ion exchange module can thus be prevented, such that a particularly long retention time of the coolant can be achieved in the ion exchange module and thus a particularly extensive de-ionisation of the coolant is also achieved. The flow guiding elements can hereby provide, in particular, a meandering flow path for the coolant through the ion exchange module, so as to use the ion exchange material located in the ion exchange module in a particularly extensive manner.

It has also been shown to be advantageous if an external wall of the ion exchange module is designed at least in some regions as being transparent. In this way, the status of the ion exchange cartridge can be controlled.

Finally, it has been shown to be advantageous if the component of the coolant circuit is designed as a coolant-equalizing reservoir or as a cooler. Such components enable, namely, a connection of the ion exchange module to the component which is particularly advantageous with respect to space. Due to the size of these components, the connection of the ion exchange module is likewise facilitated, for example in comparison to connecting the ion exchange module to a line of the coolant circuit, which is also conceivable.

In the method according to the invention for the fluidic coupling of an ion exchange module with a component of a coolant circuit for a fuel cell system that is flowed through by coolant during the cooling operation, the ion exchange module is fixed to an external wall of the component.

The advantages and preferred embodiments described for the coolant circuit according to the invention are also valid for the method according to the invention.

The features and feature combinations cited in the description above and the features and feature combinations cited below in the description of the figures and/or shown in the figures alone can be used not only in each specified combination, but rather also in other combinations or individually, without exceeding the scope of the invention.

### BRIEF DESCRIPTION OF THE DRAWING FIGURES

Further advantages, features and details of the invention arise from the claims, the description of preferred embodiments below and with the aid of the figures. The following are shown:

FIG. 1 a section of a coolant-equalizing reservoir, which is embedded into a coolant circuit for a fuel cell system, wherein an ion exchange cartridge is fixed to an external wall of the coolant-equalizing reservoir, wherein the ion exchange cartridge has a stepped floor and wherein two connecting sockets are arranged on the floor of the ion exchange cartridge, via which the coolant-equalizing reservoir is coupled to the ion exchange cartridge;

FIG. 2 a second embodiment, wherein the ion exchange cartridge is connected to the coolant-equalizing reservoir via connecting sockets that are arranged on its side wall;

FIG. 3 a further embodiment, wherein, on the floor of the ion exchange cartridge and on its side wall, each connecting socket is provided to fasten the same to the coolant-equalizing reservoir; and

FIG. 4 a further embodiment, wherein a coolant outlet and a coolant inlet are provided by connecting sockets arranged coaxially on the floor of the ion exchange cartridge.

### DETAILED DESCRIPTION

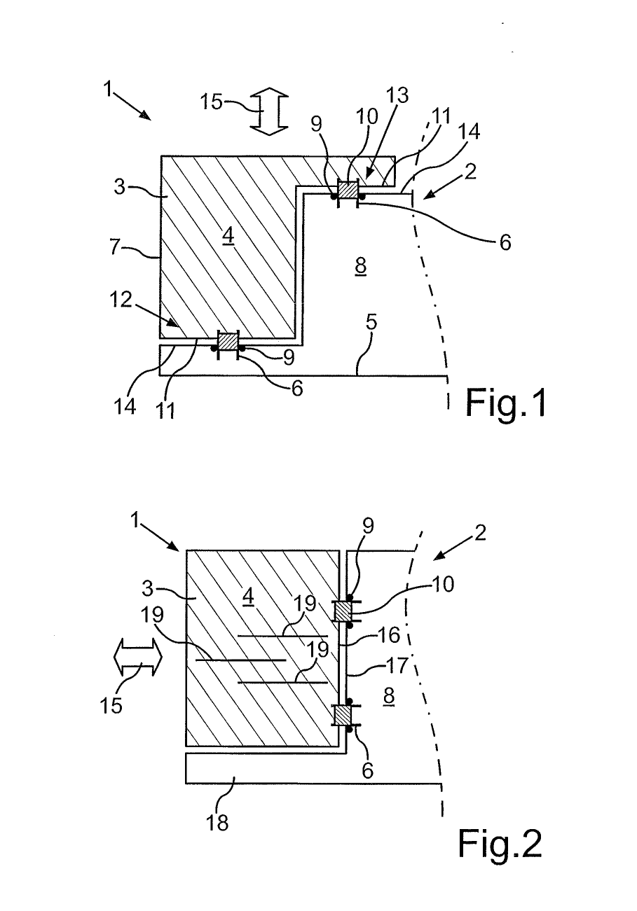

FIG. 1 illustrates a section of a coolant circuit 1 for cooling components of a fuel cell system that comprises a coolant-equalizing reservoir 2 fluidically coupled to an ion exchange cartridge 3. During the operation of the coolant circuit, coolant flows from the coolant-equalizing reservoir 2 through the ion exchange cartridge 3, and an ion exchange resin 4 arranged in the ion exchange cartridge 3 serves to de-ionize the coolant. The de-ionized coolant is present for the cooling of a fuel cell sequence in the fuel cell system. The lack of ions in the coolant is important so that, in the region of the fuel cell sequence, there is no electrical contact between components of the fuel cell sequence that are to be insulated from one another. Also, during maintenance of the coolant circuit 1, no electrical charge should be transferred via the coolant to maintenance personnel.

In the present case, the ion exchange cartridge 3 is externally mounted onto the coolant-equalizing reservoir 2. For this, apertures are provided in an external wall 5 of the coolant-equalizing reservoir 2, into which connecting sockets 6 are inserted. A latching connection, a screw connection, a connection in the form of a bayonet lock or a clip are provided to fix the ion exchange cartridge 3 to the external wall 5 of the coolant-equalizing reservoir 2. Due to such components that correspond to one another in the region of the connecting sockets 6, a quick, functionally secure and pollutant-free mounting or demounting of the ion exchange cartridge 3 to or from the external wall 5 of the coolant-equalizing reservoir 2 can be achieved.

The connecting sockets 6, of which there are, for example, two in the present case, can be integral with an external wall 7, the ion exchange cartridge 3, or the external wall 5 of the coolant-equalizing reservoir 2. Likewise, a section of the connecting socket 6 can be arranged on the ion exchange cartridge 3 and a corresponding section of the connecting socket 6 can be arranged on the coolant-equalizing reservoir 2.

Coolant from an internal space 8 of the coolant-equalizing reservoir 2 can enter the ion exchange cartridge 3 via both connecting sockets 6. A respective sealing ring 9 serves to tightly fit the connecting socket 6—presently arranged on the ion exchange cartridge 3—to the aperture provided in the external wall 5 of the coolant-equalizing reservoir 2.

In addition to the sealing ring 9, a latching element can be provided, which provides a secure and simple fastening of the ion exchange cartridge 3 to the external wall 5 of the coolant-equalizing reservoir 2. Additionally or alternatively to the sealing ring 9, a screwing aid can also be provided, or both a sealing element and a screwing aid can be provided through the sealing ring 9.

The respective connecting sockets 6 preferably also include a filter 10, which retains the ion exchange resin 4 in the ion exchange cartridge 3.

The ion exchange resin 4 can completely or partially fill the ion exchange cartridge 3 and be exchangeable, or provision can be made for an exchange of the ion exchange resin to render it necessary for the ion exchange cartridge 3 to be exchanged. In alternative embodiments, the ion exchange cartridge 3 can also contain a separate ion exchanger, which itself contains the ion exchange resin. Then the ion exchanger can hereby by removed from the ion exchange cartridge 3, e.g. on a particularly clear working area, and be replaced before the ion exchange cartridge 3 is fluidically re-coupled to the coolant-equalizing reservoir 2.

The ion exchange material or ion exchange resin 4 can be contained as filling in the ion exchange cartridge 3 or the ion exchange material can be contained as filling in the exchangeable ion exchanger.

In the embodiment shown in FIG. 1, the ion exchange cartridge 3 is cross-sectionally L-shaped and a floor 11 of the ion exchange cartridge 3 forms a step. A first of the two connecting sockets 6 is hereby arranged at a lower region 12 of the floor 11 and the second of the two connecting sockets 6 is arranged at an upper region 13 of the floor 11. The coolant-equalizing reservoir 2 has a shape that is complementary to the shape of the ion exchange cartridge 3, wherein both apertures for the connecting sockets 6 are designed on an upper side 14 of the coolant-equalizing reservoir 2. Due to the arrangement of the connecting sockets 6, a mounting device is provided during the mounting or demounting of the ion exchange cartridge 3, which is illustrated in FIG. 1 by a dual arrow 15. The ion exchange cartridge 3 is mounted and demounted accordingly from above, so in a direction that is perpendicular to the floor 11. Sealing and guide geometry is provided by the sealing rings 9 and the connecting sockets 6, which enables defect-free mounting and demounting of the ion exchange cartridge 3 onto and from the coolant-equalizing reservoir 2.

In the embodiment shown in FIG. 2, two connecting sockets 6 are arranged on a side wall 16 of the ion exchange cartridge 3 and the corresponding apertures are arranged in the coolant-equalizing reservoir 2 on its lateral external wall 17. Here, mounting and demounting of the ion exchange cartridge 3 is provided from the side, as is illustrated by the dual arrow 15 in FIG. 2. In the embodiment shown in FIG. 2, the ion exchange cartridge 3 additionally has a shape that, when mounted, fills a receiving region provided at the coolant-equalizing reservoir 2 in a flush manner. Correspondingly, a sectional region 18 of the coolant-equalizing reservoir 2 is arranged beneath the ion exchange cartridge 3. Flow guiding elements 19 can be provided in the interior of the ion exchange cartridge 3, which provide a—presently meandering—flow path of the coolant through the ion exchange cartridge 3.

If the ion exchange cartridge 3 is flowed through in a vertical direction and thus in the direction of gravity, it can be ensured in a particularly extensive manner that it will not lead to the ion exchange resin 4 being flushed out and thus to there being undesired channel formation in the ion exchange resin 4. This particularly applies when the ion exchange cartridge 3 is flowed through from bottom to top.

This furthermore leads to a particularly long retention time of the coolant in the ion exchange cartridge 3 and thus to a particularly extensive de-ionisation of the coolant. Additionally, due to the comparably small cross sections of the connecting sockets 6, there is only a small possibility for impurities to infiltrate the ion exchange cartridge 3. In the present case, this can be supported by the fact that the apertures have auto-locking locking elements for the connecting sockets 6, such that, after the ion exchange cartridge 3 has been demounted, there are no openings in the coolant-equalizing reservoir 2 via which impurities could infiltrate these. Additionally, in this way, coolant can escape from the coolant-equalizing reservoir 2.

In order to keep the infiltration of impurities into the coolant particularly low when the ion exchange cartridge 3 is being handled, provision can additionally be made for the ion exchange cartridge 3 to be delivered and mounted in a dirt-proof protective sleeve. Such a protective sleeve can additionally prevent air moisture infiltrating the ion exchange resin 4 during mounting and thus the ion exchange resin 4 being deteriorated.

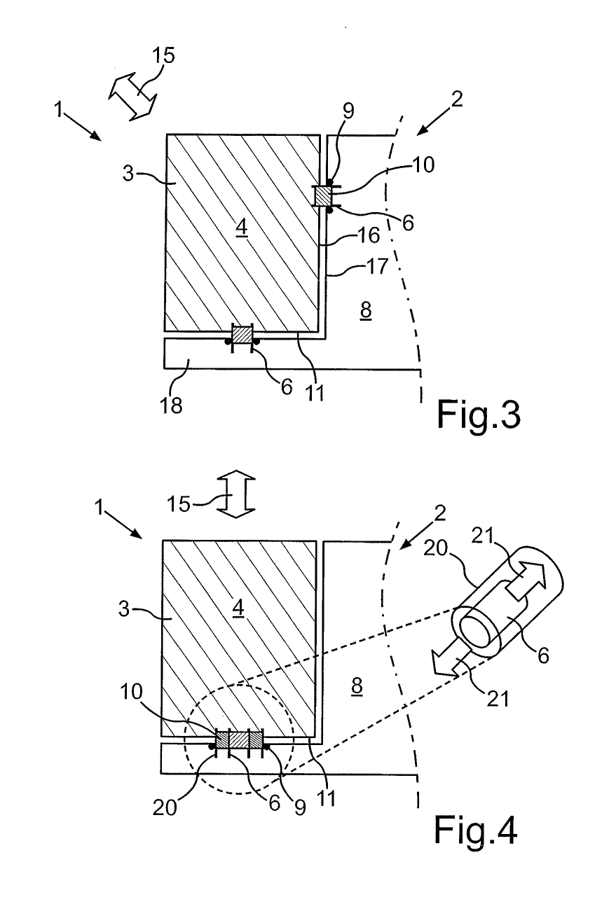

In the embodiment shown in FIG. 3, a first connecting socket 6 is arranged on the side wall 16 of the ion exchange cartridge 3 and a second connecting socket 6 is arranged on its floor 11. Even here, the coolant-equalizing reservoir 2 has a cross-sectionally L-shaped receiving region for the ion exchange cartridge 3, into which this can be inserted flush along with the external wall 5 of the coolant-equalizing reservoir 2.

In this arrangement of the connecting socket 6, which corresponds to the apertures in the coolant-equalizing reservoir 2 arranged in the side wall 17 and in the lower region 18 of the coolant-equalizing reservoir 2, the mounting and demounting of the ion exchange cartridge 3 is carried out angularly from the top or towards the top, as is illustrated by the corresponding dual arrow 15. Also, the fluidic coupling to the coolant-equalizing reservoir 2 can first be produced by the connecting sockets 6 provided above the floor 11 of the ion exchange cartridge 3, wherein the ion exchange cartridge 3 is moved from above and below. Then, in a rotational movement, the second connecting socket 6, which is provided in the side wall 17 of the ion exchange cartridge 3 is brought into engagement with the aperture provided in the side wall 17 of the coolant-equalizing reservoir 2.

Also, in the embodiment shown in FIG. 3, flow guiding elements can be provided in the interior of the ion exchange cartridge 3, so as to provide a flow path of the coolant through the ion exchange cartridge 3.

In the embodiment shown in FIG. 4, the mounting or demounting of the ion exchange cartridge 3 also takes place in a vertical direction (cf. dual arrow 15), wherein a first connecting socket 6 is provided in the floor 11 of the ion exchange cartridge 3, which is surrounded by a second connecting socket 20 at its peripheral surface. The entry of the coolant into the ion exchange cartridge 3 can hereby take place via the internal connecting socket 6 and the exit of the de-ionized coolant can take place from the ion exchange cartridge 3 via the external, coaxial connecting socket 20. Here it is only necessary for one sealing ring 9 to be provided for both connecting sockets 6, 20.

FIG. 4 additionally shows both coaxial connecting sockets 6 in a perspective view, in which the respective flow direction of the coolant through this fastening element is illustrated by flow arrows 21.

Also, in the embodiment shown in FIG. 4, the ion exchange cartridge 3 fills a receiving region for the ion exchange cartridge 3, provided by the coolant-equalizing reservoir 2, in such a way that the external wall of both of these components close flush to one another.

In alternative embodiments, the ion exchange cartridge 3 can also be mounted externally onto a cooler, as an example for a component of the coolant circuit 1, and not onto the external wall of the coolant-equalizing reservoir 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Coolant circuit
2 Coolant equalizing reservoir
3 Ion exchange cartridge
4 Ion exchange resin
5 External wall
6 Connecting socket
7 External wall
8 Internal space
9 Sealing ring
10 Filter
11 Floor
12 Region
13 Region
14 Upper side
15 Dual arrow
16 Side wall
17 External wall
18 Region
19 Flow guiding element
20 Connecting socket
21 Flow arrow

1-14. (canceled)

15. A coolant circuit for a fuel cell system of a motor vehicle, comprising:
a component of the coolant circuit that is flowed through by coolant during a cooling operation; and
an ion exchange module fluidically coupled to the component of the coolant circuit that is flowed through by coolant during a cooling operation, wherein the ion exchange module is fixed to an external wall of the component.

16. The coolant circuit according to claim 15, wherein the ion exchange module is fixed to the external wall of the component by at least one fastening element that is configured to be flowed through by the coolant.

17. The coolant circuit according to claim 16, wherein due to the arrangement of the at least one fastening element, a mounting device is provided during the coupling of the ion exchange module to the component.

18. The coolant circuit according to claim 16, wherein the external wall of the component forms a receiving region configured to be filled by the ion exchange module so that the ion exchange module is flush with the external wall of the component.

19. The coolant circuit according to claim 16, wherein
the ion exchange module has a floor with a step, wherein the at least one fastening element is arranged at a region of the floor that is displaceable around a height of the step,
the at least one fastening element includes at least two fastening elements arranged on a side wall of the ion exchange module, or
a first fastening element of the at least one fastening element is arranged on a side wall and a second fastening element of the at least one fastening element is arranged on a floor of the ion exchange module.

20. The coolant circuit according to claim 16, wherein the at least one fastening element comprises a socket arranged on the ion exchange module or on the component of the coolant circuit.

21. The coolant circuit according to claim 16, wherein the at least one fastening element comprises a bayonet lock, a latching element, or a screw thread.

22. The coolant circuit according to claim 16, wherein the at least one fastening element comprises a sealing element or a filter.

23. The coolant circuit according to claim 16, further comprising:
a locking element configured to prevent coolant from escaping from the component in a region of the at least one fastening element when the ion exchange module is uncoupled from the component.

24. The coolant circuit according to claim 16, wherein the at least one fastening element includes a first fastening element surrounded by a second fastening element on its peripheral surface.

25. The coolant circuit according to claim 15, further comprising:
at least one flow guiding element arranged in the ion exchange module, which is configured to provide a meandering flow path for the coolant through the ion exchange module.

26. The coolant circuit according to claim 15, wherein an external wall of the ion exchange module is configured so that has at least some transparent regions.

27. The coolant circuit according to claim 15, wherein the component of the coolant circuit is a coolant-equalizing reservoir or a cooler.

28. A method for the fluidic coupling of an ion exchange module with a component of a coolant circuit for a fuel cell system of a motor vehicle, that is flowed through by coolant during a cooling operation, comprising:
fixing the ion exchange module to an external wall of the component.
